(19) United States
(12) Patent Application Publication
(10) Pub. No.: US 2025/0336583 A1
(43) Pub. Date: Oct. 30, 2025

(54) DUST CORE AND METHOD FOR MANUFACTURING DUST CORE

(71) Applicant: Panasonic Intellectual Property Management Co., Ltd., Osaka (JP)

(72) Inventors: Kazuki NOGUCHI, Hyogo (JP); Toru IWABUCHI, Kyoto (JP); Hitoshi HORIUCHI, Hyogo (JP)

(73) Assignee: Panasonic Intellectual Property Management Co., Ltd., Osaka (JP)

(21) Appl. No.: 18/876,342

(22) PCT Filed: Jun. 1, 2023
(86) PCT No.: PCT/JP2023/020454

§ 371 Date: Dec. 18, 2024

(30) Foreign Application Priority Data
Jun. 28, 2022 (JP) 2022-103326

(51) Int. Cl. H01F 3/08; H01F 41/02

(52) U.S. Cl. CPC H01F 3/08; H01F 41/0246

(57) ABSTRACT

A dust core includes: a metal magnetic powder including a plurality of metal magnetic particles; and a binding agent that binds the plurality of metal magnetic particles of the metal magnetic powder. The binding agent includes a Cr element.

### TECHNICAL FIELD

The present disclosure relates to a dust core and a method for manufacturing a dust core.

### BACKGROUND ART

Various electronic devices include, for example, a DC/DC converter circuit and a step-up/down circuit that adjusts power supply voltage as a drive circuit of the electronic device. An inductor, such as a choke coil and a transformer, is used in these circuits.

Conventionally known inductors include inductors that include a dust core fabricated by pressure-molding a composite magnetic material obtained by mixing a metal magnetic powder and a binding agent since the DC superimposition characteristics are superior, for example. The dust core is required to have an anti-rust effect from the viewpoint of maintaining the characteristics and the reliability for a long time. For example, Patent Literature (PTL) 1 discloses a dust core formed from a composite magnetic material including a metal magnetic powder, a binder resin, and a metallic soap having a melting point equal to or lower than the thermosetting temperature of the binder resin.

### CITATION LIST

### Patent Literature

[PTL 1] Japanese Unexamined Patent Application Publication No. 2018-41872

### SUMMARY OF INVENTION

### Technical Problem

An object of the present disclosure is to provide a dust core and the like that can have both magnetic characteristics and an anti-rust effect.

### Solution to Problem

A dust core according to an aspect of the present disclosure is a dust core including: a metal magnetic powder including a plurality of metal magnetic particles; and a binding agent that binds the plurality of metal magnetic particles of the metal magnetic powder, wherein the binding agent includes a Cr element.

In addition, a method for manufacturing a dust core according to an aspect of the present disclosure is a method including: mixing a metal magnetic powder, a resin, and a metallic soap to obtain a granulated powder in which the metal magnetic powder and a binding agent including the resin and the metallic soap are mixed, the metal magnetic powder including a plurality of metal magnetic particles; and pressure-molding the granulated powder obtained, wherein in the mixing, the metallic soap is in liquid form at 25° C. and includes a Cr element.

### Advantageous Effects of Invention

According to the present disclosure, the dust core can have both magnetic characteristics and an anti-rust effect.

### BRIEF DESCRIPTION OF DRAWINGS

FIG. 1 is a schematic perspective view showing a configuration of an electrical component that includes a dust core according to an embodiment.

FIG. 2 is a diagram schematically showing a cross section of the dust core according to the embodiment.

FIG. 3 is a flowchart showing a method for manufacturing the dust core according to the embodiment.

FIG. 4 is a diagram showing an image of a cross section of a dust core according to Evaluation Example 6.

FIG. 5 is a diagram showing a relationship between the amount of a Cr element or Zn element detected and the magnetic permeability μᵢ ratio of dust cores in evaluation examples.

FIG. 6 is a diagram showing a relationship between the amount of the Cr element or Zn element detected and the magnetic permeability μ_{85Oe} ratio of the dust cores in the evaluation examples.

FIG. 7 is a diagram showing a relationship between the amount of the Cr element or Zn element detected and the breakdown voltage of the dust cores in the evaluation examples.

### DESCRIPTION OF EMBODIMENTS

### (Underlying Knowledge Leading to an Aspect of the Present Disclosure)

Recently, inductors are required to address high current, and in order to improve the DC superimposition characteristics, it is effective to raise the ratio of the Fe (iron) element, which has a higher saturation magnetic flux density, in the metal magnetic powder included in the dust core. However, as the ratio of the Fe element in the metal magnetic powder is raised, rust is more likely to occur, and the anti-rust effect decreases.

PTL 1 discloses that the anti-rust effect of the dust core can be improved by coating the part of the metal magnetic powder that is not covered with the binder resin with a metallic soap. However, if the metal magnetic powder is coated with a metallic soap as disclosed in PTL 1, the distances between the particles of the metal magnetic powder increase because of the presence of the metallic soap, and the magnetic characteristics (such as magnetic permeability) of the dust core decreases. Thus, the inventors have found that according to the conventional techniques, it is difficult to inhibit the decrease of the magnetic characteristics of the dust core while improving the anti-rust effect.

In view of the problems described above, the present disclosure provides a dust core and the like that can have both magnetic characteristics and an anti-rust effect by inhibiting the decrease of the magnetic characteristics, such as magnetic permeability, while improving the anti-rust effect.

### [Overview of Present Disclosure]

Hereinafter, a plurality of examples of a dust core according to the present disclosure will be shown.

<1> A dust core including:
a metal magnetic powder including a plurality of metal magnetic particles; and
a binding agent that binds the plurality of metal magnetic particles of the metal magnetic powder,
wherein the binding agent includes a Cr element.

<2> The dust core according to <1>,
wherein a percentage of the Cr element relative to a sum of a Si element, a C element, an O element, a N element, and the Cr element in the binding agent is at least 0.20 wt % and at most 5.28 wt %.

<3> The dust core according to <1> or <2>,
wherein a content of an Fe element in the metal magnetic powder is at least 90.0 wt %.

<4> The dust core according to <3>,
wherein the content of the Fe element in the metal magnetic powder is at least 99.5 wt %.

Hereinafter, a plurality of examples of a method for manufacturing a dust core according to the present disclosure will be shown.

<5> A method for manufacturing a dust core, the method including:
mixing a metal magnetic powder, a resin, and a metallic soap to obtain a granulated powder in which the metal magnetic powder and a binding agent including the resin and the metallic soap are mixed, the metal magnetic powder including a plurality of metal magnetic particles; and
pressure-molding the granulated powder obtained,
wherein in the mixing, the metallic soap is in liquid form at 25° C. and includes a Cr element.

<6> The method according to <5>,
wherein in the mixing, a percentage of the metallic soap relative to the metal magnetic powder in the granulated powder is at least 0.1 wt % and at most 2.0 wt %.

<7> The method according to <5> or <6>,
wherein in the pressure-molding, a percentage of the Cr element relative to a sum of a Si element, a C element, an O element, a N element, and the Cr element in the binding agent included in the granulated powder that is pressure-molded is at least 0.20 wt % and at most 5.28 wt %.

<8> The method according to any one of <5> to <7>,
wherein in the mixing, the granulated powder is obtained by obtaining a mixture of the metal magnetic powder and the metallic soap and then mixing the mixture and the resin.

Hereinafter, an embodiment will be specifically described with reference to the drawings.

Note that each of the embodiments described below illustrates a specific example of the present disclosure. The numerical values, shapes, materials, constituent elements, the arrangement and connection of the constituent elements, steps, the processing order of the steps, etc. illustrated in the embodiments below are mere examples, and are not intended to limit the present disclosure. Among the constituent elements in the embodiments below, constituent elements not recited in any one of the independent claims will be described as optional constituent elements.

The drawings are represented schematically and are not necessarily precise illustrations. Therefore, the scales, for example, are not necessarily consistent from drawing to drawing. In the drawings, essentially the same constituent elements share the same reference signs, and redundant descriptions will be omitted or simplified.

In the present specification, terms indicating a relationship between elements such as “parallel” and “orthogonal”, terms indicating the shape of elements such as “rectangular” and “rectangular parallelepiped”, and numerical value ranges do not represent their strict meanings only but also include substantially equivalent ranges, e.g., differences of several percent.

### Embodiment

### [Configuration]

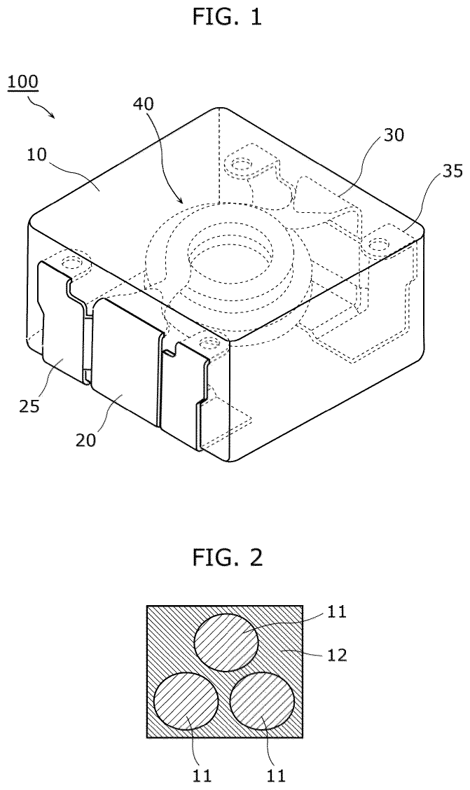

First, an electrical component will be described with reference to FIG. 1 and FIG. 2 as a usage example of a dust core according to an embodiment.

FIG. 1 is a schematic perspective view showing a configuration of the electrical component that includes the dust core according to the embodiment. FIG. 1 shows the outline of dust core 10, which will be described later, and further shows the inside of dust core 10 in a transparent manner. For example, constituent elements invisible by being embedded in dust core 10, such as coil member 40, are illustrated with broken lines to show that such constituent elements are seen through dust core 10.

As shown in FIG. 1, electrical component 100 includes dust core 10, coil member 40, first terminal member 25, and second terminal member 35.

Electrical component 100 is, for example, an inductor having a rectangular parallelepiped shape, and a rough profile of electrical component 100 is determined by the shape of dust core 10. Note that dust core 10 can be formed into any shape by pressure-molding. That is to say, any shape of electrical component 100 can be achieved by shaping dust core 10 through pressure-molding. Therefore, the shape of the dust core is not limited to a rectangular parallelepiped shape and may be a different shape.

Electrical component 100 is a passive element in which coil member 40 stores, as magnetic energy, electrical energy flowing between first terminal member 25 and second terminal member 35. In the present embodiment, electrical component 100 will be described as one usage example of dust core 10; however, dust core 10 may be simply used as a magnetic material, and the usage example of dust core 10 is not limited to electrical component 100 according to the present embodiment. Dust core 10 may be used for a desired application in which the characteristics of the magnetic material having both magnetic characteristics and an anti-rust effect can be used.

Dust core 10 has a substantially quadrangular prism shape having rectangular opposing surfaces on which first terminal member 25 and second terminal member 35 are formed. The respective four sides of the opposing surfaces are connected by the top surface, the bottom surface, and two side surfaces of the substantially quadrangular prism. In the present embodiment, the bottom surface and the top surface of dust core 10 each have a rectangular shape with the dimensions of about 14.0 mm×12.5 mm, for example, and the separation distance from the bottom surface to the top surface is about 8.0 mm.

FIG. 2 is a diagram schematically showing a cross section of dust core 10. FIG. 2 is an enlarged view of a portion of a cross section of dust core 10.

As shown in FIG. 2, dust core 10 includes: metal magnetic powder 11 including a plurality of metal magnetic particles; and binding agent 12 that binds the plurality of metal magnetic particles of metal magnetic powder 11.

As metal magnetic powder 11, a metal magnetic powder primarily including an Fe element is used, for example. Metal magnetic powder 11 has a high saturation magnetic flux density as compared to magnetic powders such as ferrite, thus being useful for use under high current.

The content of the Fe element in metal magnetic powder 11 is at least 90.0 wt % (percentage by weight), for example. According to this, the saturation magnetic flux density of metal magnetic powder 11 increases, and the magnetic permeability of dust core 10 can be increased.

Metal magnetic powder 11 may include an element other than the Fe element. Examples of the element other than the Fe element that may be included in metal magnetic powder 11 include a Si (silicon) element, an Al (aluminum) element, a Cr (chromium) element, and a B (boron) element.

From the viewpoint of further increasing the magnetic permeability of dust core 10, the content of the Fe element in metal magnetic powder 11 may be at least 99.5 wt %. Metal magnetic powder 11 having a content of the Fe element of at least 99.5 wt % include the Fe element and inevitable impurities, for example. Examples of the inevitable impurities include a Mn (manganese) element, a Ni (nickel) element, a P (phosphorus) element, a S (sulfur) element, a C (carbon) element, and an O (oxygen) element.

The method for fabricating metal magnetic powder 11 is not particularly limited, and various atomization methods, various chemical methods, or various pulverization methods can be used.

When fabricating metal magnetic powder 11 having a content of the Fe element of at least 99.5 wt %, the carbonyl method, the atomizing method, or the electrolysis method is used, for example. From the viewpoint of the magnetic characteristics, metal magnetic powder 11 may be a carbonyl iron powder fabricated in the carbonyl method.

Median diameter D50 of metal magnetic powder 11 is at least 1.0 μm and at most 35 μm, for example. To alleviate the concentration of the electric field among the particles, median diameter D50 of metal magnetic powder 11 can be set to be lower, thereby ensuring the insulating properties. By setting median diameter D50 as described above, high filling factor and handleability can be ensured. By setting median diameter D50 of metal magnetic powder 11 to be at most 35 μm, the core loss and, in particular, the eddy current loss can be reduced in a high frequency region. Note that median diameter D50 of metal magnetic powder 11 is a particle diameter when particle diameters are counted in ascending order in a particle size distribution measured in the laser diffraction and scattering method until the integrated value reaches 50% of the total count.

Binding agent 12 is provided to cover metal magnetic powder 11. Binding agent 12 is located between the metal magnetic particles of metal magnetic powder 11. Binding agent 12 is an insulating resin material primarily including a resin. Binding agent 12 includes a resin and a metallic soap, for example. Binding agent 12 may further include a coupling agent and insulating particles (such as inorganic particles such as talc particles).

The resin is a thermosetting resin, for example. Examples of the thermosetting resin include epoxy resins, phenolic resins, silicone resins, and polyimide resins, for example. The resin may also be a thermoplastic resin. Examples of the thermoplastic resin include acrylic resins, polyethylene, polypropylene, and polystyrene, for example. Binding agent 12 may include a plurality of kinds of resins.

Binding agent includes the Cr element. Constituents including the Cr element of binding agent 12 are distributed in the resin, for example. Since the constituents including the Cr element are distributed in the resin, the Cr element exhibits the effect of improving the anti-rust effect and equally attracts the metal magnetic particles and the resin, so that the decrease of the magnetic characteristics of dust core 10 can be inhibited. The Cr element included in binding agent 12 derives from the metallic soap, for example. As the constituent including the Cr element, binding agent 12 includes a metallic soap including the Cr element and/or a reactant of the metallic soap including the Cr element.

The percentage of the Cr element relative to the sum of a Si element, a C element, an O element, a N (nitrogen) element, and the Cr element in binding agent 12 is at least 0.20 wt % and at most 5.28 wt %, for example. According to this, the decrease of the magnetic characteristics of dust core 10 can be effectively inhibited, and the anti-rust effect can be improved. From the viewpoint of further inhibiting the decrease of the magnetic characteristics of dust core 10, the percentage of the Cr element may be at least 1.08 wt % and at most 5.28 wt %.

The Si element, the C element, the O element, and the N element are elements that can be easily detected by the elemental analysis and primary elements included in a resin used for common binding agent 12. Therefore, the percentage of the Cr element is an index of the content of the Cr element in binding agent 12.

Although the method for measuring the percentage of the Cr element in binding agent 12 is not particularly limited, for example, the percentage is calculated based on the elemental analysis of the regions between the metal magnetic particles of metal magnetic powder 11 in an image of the cross section of dust core 10.

Specifically, first, the Si element, the C element, the O element, the N element, and the Cr element are detected on a weight basis at 15 measurement points between the metal magnetic particles of metal magnetic powder 11 in an image of the cross section of dust core 10. Then, an average value of the percentages of the Cr element relative to the sum of the Si element, the C element, the O element, the N element, and the Cr element at the measurement points is calculated. The calculated value is regarded as the percentage of the Cr element in binding agent 12. Note that among the measurement points, any measurement point where the percentage of an element other than the Si element, the C element, the O element, the N element, and the Cr element is high in the elemental analysis can be excluded from the calculation of the average value. For example, the detection result at a measurement point where the percentage of the Fe element deriving from metal magnetic powder 11 is equal to or higher than a predetermined threshold is excluded from the calculation of the average value. The predetermined threshold is 88.0 wt %, for example. The number of the measurement points described above is an example, and the number of the measurement points is not limited to 15. For example, N measurement points (N denotes an integer equal to or greater than 10, for example) are possible.

The image of the cross section of dust core 10 is, for example, a scanning electron microscope (SEM) image. The elements are detected at each measurement point using, for example, an energy dispersive X-ray (EDX) spectrometer. For example, using scanning electron microscopy-energy dispersive X-ray spectroscopy (SEM-EDX), the amount of each element detected on a weight basis is calculated from the peak intensity corresponding to the element in the EDX spectrum obtained at each measurement point.

To form a cross section of dust core 10, a cross-section forming method in general SEM image observation is used. For example, dust core 10 is embedded using resin or the like and cut, and is then subjected to ion milling to obtain a cross section of dust core 10 for observation.

An image of a region of at least 15 μm×15 μm and at most 50 μm×50 μm, for example, is used as the image of a cross section for detecting the elements at each measurement point. The magnification of the cross-section image is, for example, at least 1000 times and at most 7000 times. Fifteen measurement points are selected from the regions between the metal magnetic particles of metal magnetic powder 11 of different combinations. When measurement points where the percentage of the Fe element deriving from metal magnetic powder 11 is equal to or higher than a predetermined threshold are included as described above, if more than half of the measurement points are such measurement points, the result is discarded, and the measurement is performed again.

The percentage of binding agent 12 relative to metal magnetic powder 11 in dust core 10 is at least 1 wt % and at most 10 wt %, for example.

Continuing to refer to FIG. 1, coil member 40, first terminal member 25, and second terminal member 35 will be described.

Coil member 40 has a conducting wire, which is an elongated conductor covered by an insulating film, wound around it (a wound portion), and the two ends of the conducting wire are connected to first terminal member 25 and second terminal member 35 (lead portions 20 and 30). In the present embodiment, a round conducting wire having a cross-sectional diameter of about 0.65 mm is used as the conductor. There is no particular limitation on the thickness and shape of the conducting wire. As long as the conducting wire is thick enough to allow winding processing etc., a flat rectangular conducting wire having a rectangular cross section, a round conducting wire, and so on can be selected and used as appropriate. The wound portion is embedded in the vicinity of the center of dust core 10. At lead portions 20 and 30, each of the two ends of the conducting wire extends continuously from the wound portion to a corresponding one of the opposing surfaces and protrudes outward from dust core 10. Here, part of each lead portion is extended to form a flat shape and is bent along the corresponding one of the opposing surfaces and the bottom surface. At the extended part, the insulating film cover is removed to allow electrical connection to the outside.

First terminal member 25 and second terminal member 35 are conductor plates made of, for example, a phosphor bronze material or a copper material. Each of first terminal member 25 and second terminal member 35 has a recess in the vicinity of its center along a corresponding one of the opposing surfaces and is recessed into dust core 10. Lead portions 20 and 30 are provided outside the recesses. Lead portion 20 and first terminal member 25 are electrically connected. Lead portion 30 and second terminal member 35 are electrically connected. Lead portions 20 and 30 are connected to first terminal member 25 and second terminal member 35, respectively, by resistance welding or the like. First terminal member 25 and second terminal member 35 are bent to be inserted into the inside of dust core 10, and are fixed to dust core 10 with the bent portions inserted into dust core 10.

First terminal member 25 and second terminal member 35, together with lead portions 20 and 30, are bent along the bottom surface of dust core 10. With this, lead portions 20 and 30 are partially located at the bottom side of electrical component 100 while being held by first terminal member 25 and second terminal member 35. That is to say, lead portions 20 and 30 can be directly connected to the land (not illustrated) of a mounting board or the like on which electrical component 100 is mounted.

Note that first terminal member 25 and second terminal member 35 are not essential constituent elements. First terminal member 25 and second terminal member 35 need not be included if lead portions 20 and 30 are strong enough to maintain their shape by themselves.

As described above, dust core 10 according to the present embodiment includes metal magnetic powder 11 and binding agent 12 including the Cr element. Therefore, binding agent 12 including the Cr element covers the metal magnetic particles of metal magnetic powder 11 to improve the corrosion resistance of metal magnetic powder 11. In addition, the Cr element in binding agent 12 attracts binding agent 12 and the metal magnetic particles of metal magnetic powder 11 to reduce the distances between the metal magnetic particles. In this way, dust core 10 can have both magnetic characteristics and an anti-rust effect.

### [Manufacturing Method]

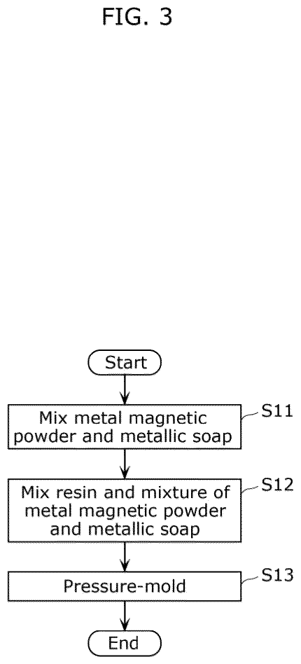

Next, a method for manufacturing above-described dust core 10 will be described with reference to FIG. 3.

FIG. 3 is a flowchart showing the method for manufacturing the dust core according to the embodiment.

To manufacture dust core 10 according to the present embodiment, first, metal magnetic powder 11 and a metallic soap are mixed (step S11). In this way, a mixture of metal magnetic powder 11 and the metallic soap is obtained. In step S11, the mixture does not substantially include a resin.

The metallic soap includes the Cr element. Specifically, the metallic soap is fatty acid chromium. The metallic soap is in a liquid state at 25° C. (room temperature). That is, the melting point of the metallic soap is lower than 25° C. Therefore, in step S11, metal magnetic powder 11 is mixed with the metallic soap in a liquid state. The metallic soap in a liquid state has a branch in a hydrocarbon chain of the fatty acid, in order to decrease the melting point. The metallic soap is manufactured in a direct method or a double decomposition method, for example. The direct method is a method in which a fatty acid directly reacts with a metal oxide or a metal hydroxide. The double decomposition method is a method in which a fatty acid reacts with a basic compound in a solution to form a basic compound of the fatty acid, which further reacts with a metal salt containing a metal or a semimetal.

By mixing metal magnetic powder 11 and the metallic soap in a liquid state before a resin is mixed, the surface of the metal magnetic particles of metal magnetic powder 11 and a hydrophilic part of the metallic soap can easily react with each other, and the metallic soap can effectively work.

Next, resin is added to the mixture obtained in step S11 to mix the mixture and the resin (step S12). In this way, a granulated powder including a mixture of metal magnetic powder 11 and binding agent 12 including a resin and a metallic soap is obtained.

The resin mixed in step S12 is used in a state where the resin is dissolved in a solvent in which the resin can be dissolved, such as isopropyl alcohol, acetone, toluene, xylene, ethanol, or methyl ethyl ketone. Note that the resin mixed in step S12 need not be dissolved in a solvent.

After the mixture obtained in step S11 and the resin are mixed, the mixture is heated at a temperature of at least 65° C. and at most 150° C. to evaporate the solvent and then is pulverized to obtain a granulated powder (composite magnetic material) having high moldability. This granulated powder may be further classified to obtain a granulated powder with the sizes of the particles falling within a predetermined range. In this way, the moldability can be further improved.

In step S11 and step S12, the mixing is performed using, for example, a mortar, mixer, ball mill, V-type mixer, or cross-rotary mixer.

In step S11 and/or step s12, another material, such as a coupling agent and insulating particles, may be further added and mixed, as required.

As described above, in step S11 and step S12, metal magnetic powder 11, a resin, and a metallic soap are mixed to obtain a granulated powder in which metal magnetic powder 11 and binding agent 12 including the resin and the metallic soap are mixed. The step including step S11 and step S12 is an example of the mixing.

The percentage of the metallic soap relative to metal magnetic powder 11 in the granulated powder (i.e., the added amount of the metallic soap relative to the added amount of metal magnetic powder 11) is at least 0.1 wt % and at most 2.0 wt %, for example. According to this, the decrease of the magnetic characteristics of dust core 10 can be effectively inhibited, and the anti-rust effect can be improved. From the viewpoint of further inhibiting the decrease of the magnetic characteristics of dust core 10, the percentage of the metallic soap may be at least 0.5 wt % and at most 2.0 wt %.

The percentage of the resin relative to metal magnetic powder 11 in the granulated powder (i.e., the added amount of the resin relative to the added amount of metal magnetic powder 11) is at least 1 wt % and at most 10 wt %, for example.

Note that although the mixing of metal magnetic powder 11, the resin, and the metallic soap is performed in two steps S11 and S12 in the above description, the present disclosure is not limited to this. The order of mixing metal magnetic powder 11, the rein, and the metallic soap may be different from the order described above, as far as a granulated powder including a mixture of metal magnetic powder 11, the resin, and the metallic soap is obtained. For example, metal magnetic powder 11, the resin, and the metallic soap may be mixed at the same time. Alternatively, different combinations of materials than those described above may be mixed in two or more steps.

The granulated powder obtained in step S12 is put into a mold and pressure-molded into a desired shape to obtain dust core 10 (step S13). Step S13 is an example of the pressure-molding. In step S13, the pressure-molding is performed under a pressure of at least 3 ton/cm² and at most 7 ton/cm², for example. Pressure-molded dust core 10 is subjected to curing processing by heating, for example. The conditions for the curing processing are set according to the kind of the resin used.

The percentage of the Cr element relative to the sum of the Si element, the C element, the O element, the N element, and the Cr element in binding agent 12 in the pressure-molded granulated powder is at least 0.20 wt % and at most 5.28 wt %. Thus, the decrease of the magnetic characteristics of dust core 10 can be effectively inhibited, and the anti-rust effect can be improved.

With these steps S11 to S13, dust core 10 is fabricated. Fabricated dust core 10 is used as part of electrical component 100 having a coil embedded therein. The granular powder may be pressure-molded together with coil member 40.

As described above, a method for manufacturing dust core 10 includes: mixing metal magnetic powder 11, a resin, and a metallic soap to obtain a granulated powder in which metal magnetic powder 11 and binding agent 12 including the resin and the metallic soap are mixed (step S11 and step S12); and pressure-molding the granulated powder obtained (step S13). In the mixing, the metallic soap is in liquid form at 25° C. and includes a Cr element.

Thus, the Cr element in the metallic soap reacts with metal magnetic powder 11, so that the corrosion resistance against rust of metal magnetic powder 11 can be improved. In addition, since the metallic soap is in a liquid state when it is mixed, the metallic soap is easily dispersed in the resin and is uniformly distributed in the resin and on the interface between the resin and metal magnetic powder 11. Therefore, the distance between the metal magnetic particles of metal magnetic powder 11 is less likely to increase. As a result, even though the metallic soap is added, the decrease of the magnetic characteristics of dust core 10 manufactured can be inhibited. Therefore, dust core 10 manufactured can have both magnetic characteristics and an anti-rust effect.

### [Evaluation of Dust Core]

Next, an evaluation result of the dust core according to the embodiment will be described. Specifically, the dust core was fabricated as described below, and analysis and characteristics evaluation of the fabricated dust core were performed. Note that the present embodiment is not limited to the evaluation described below in any sense.

### [Fabrication of Dust Core]

First, fabrication of the dust core used for the evaluation will be described. In Evaluation Examples 1 to 10, the dust core was fabricated in the manufacturing method described above in [Manufacturing Method]. A specific method is as follows.

First, a metal magnetic powder, a resin, and a metallic soap were prepared.

As the metal magnetic powder, a metal magnetic powder the content of an Fe element in which was at least 99.5 wt % was used.

As the resin, a modified silicone resin having a methyl group or a phenyl group in a side chain dissolved in a solvent (isopropyl alcohol) (the concentration was 50 wt %). The added amount of the resin relative to the added amount of the metal magnetic powder was 3 wt %. Note that the added amount of the resin means the added amount of the resin in weight excluding the solvent.

In Evaluation Examples 2 to 7, fatty acid chromium that is in a liquid state at 25° C. was used as the metallic soap. In Evaluation Examples 8 to 10, fatty acid zinc that is in a solid state at 25° C. was used as the metallic soap. The added amount of the metallic soap relative to the added amount of the metal magnetic powder was the amount (wt %) shown in Table 2. In the following, the metallic soap including the Cr element used in Evaluation Examples 2 to 7 may be expressed as a “Cr metallic soap”, and the metallic soap including the Zn element used in Evaluation Examples 8 to 10 may be expressed as a “Zn metallic soap”. In Evaluation Example 1, the dust core was fabricated without adding the metallic soap.

Using these materials, a granulated powder was fabricated by mixing the metal magnetic powder and the metallic soap, adding and mixing the resin, and then heating the mixture to remove the solvent. A mortar was used to mix the materials.

The prepared granulated powder was pressure-molded under a pressure of 4 tons/cm² at room temperature to fabricate ring cores each having an outer diameter of 14.4 mm, an inner diameter of 10.3 mm, and a thickness of 4.4 mm for evaluation of magnetic permeability. Furthermore, the ring cores were dried at 150° C. for 2 hours to cure the binding agent, thereby fabricating ring-shaped dust cores.

Also, the prepared granulated powder was pressure-molded under a pressure of 4 tons/cm² at room temperature to fabricate plate-shaped compacts each having a length of 12 mm, a width of 12 mm, and a thickness of 0.70 mm for evaluation of withstand voltage. Furthermore, the plate-shaped compacts were dried at 150° C. for 2 hours to cure the binding agent, thereby fabricating plate-shaped dust cores.

Also, the prepared granulated powder was pressure-molded under a pressure of 4 tons/cm² at room temperature to fabricate plate-shaped compacts each having a length of 12 mm, a width of 12 mm, and a thickness of 4.1 mm for evaluation of the anti-rust effect. Furthermore, the plate-shaped compacts were dried at 150° C. for 2 hours to cure the binding agent, thereby fabricating plate-shaped dust cores.

### [Method for Calculating Magnetic Permeability]

Inductance L of each of the ring-shaped dust cores at 0 A was measured using an LCR meter, and the magnetic permeability was calculated as magnetic permeability u using the following equation (1) (at a measurement frequency of 100 kHz). Inductance L was measured under conditions where the applied magnetic field was 0 Oe and 85 Oe, and magnetic permeabilities μ calculated from inductance L under the conditions were denoted as magnetic permeability μᵢ and magnetic permeability μ_{85Oe}. Magnetic permeability μᵢ is referred to also as an initial magnetic permeability.

$$μ = ( L \times le ) / ( {μ}_{0} \times Ae \times {n}^{2} ) \qquad ( 1 )$$

Note that le denotes the effective magnetic path length, μ₀ denotes the magnetic permeability of the vacuum, Ae denotes the cross-sectional surface area, and n denotes the number of turns of the measurement coil.

The magnetic permeability in Evaluation Example 1 was used as a reference, and the ratio of the magnetic permeability in each evaluation example relative to the magnetic permeability in Evaluation Example 1 was calculated. The ratio of the magnetic permeability calculated from inductance L for the applied magnetic field of 0 Oe is referred to as a magnetic permeability μᵢ ratio, and the ratio of the magnetic permeability calculated from inductance L for the applied magnetic field of 85 Oe is referred to as a magnetic permeability μ_{85Oe} ratio. For example, the magnetic permeability μᵢ ratio in Evaluation Example 2 is (magnetic permeability μᵢ in Evaluation Example 2)/(magnetic permeability μᵢ in Evaluation Example 1), and the magnetic permeability μ_{85Oe} ratio in Evaluation Example 2 is (magnetic permeability μ_{85Oe} in Evaluation Example 2)/(magnetic permeability μ_{85Oe} in Evaluation Example 1). A higher magnetic permeability ratio indicates more superior magnetic characteristics.

### [Method for Evaluating Breakdown Voltage]

To measure breakdown voltage that serves as an index of insulation properties, each of the plate-shaped dust cores fabricated was sandwiched between conductive rubbers disposed on both main surfaces, a DC voltage at an initial value of 10 V was applied, and thereafter the value of the applied voltage was raised continuously at a rate of 5 V/min. The value of the applied voltage immediately before occurrence of breakdown was divided by the thickness of the compact, and the value (V/mm) obtained by the division was regarded as the value of breakdown voltage of the dust core. A higher value of breakdown voltage indicates higher insulation properties. In addition, since the insulation properties are improved, the leakage current (and the eddy current loss caused thereby) of the metal magnetic powder can be inhibited, and the magnetic characteristics are improved.

### [Method for Evaluating Anti-Rust Effect]

In the evaluation of the anti-rust effect, the fabricated dust core was put in a thermo-hygrostat kept at a temperature of 65° C. and a humidity of 90% RH, and the anti-rust effect were evaluated according to the following criterion by visually checking the presence or absence of rust on the surface of the dust core after a lapse of 200 hours.
O: No rust was observed
x: Rust was observed

### [Elemental Analysis]

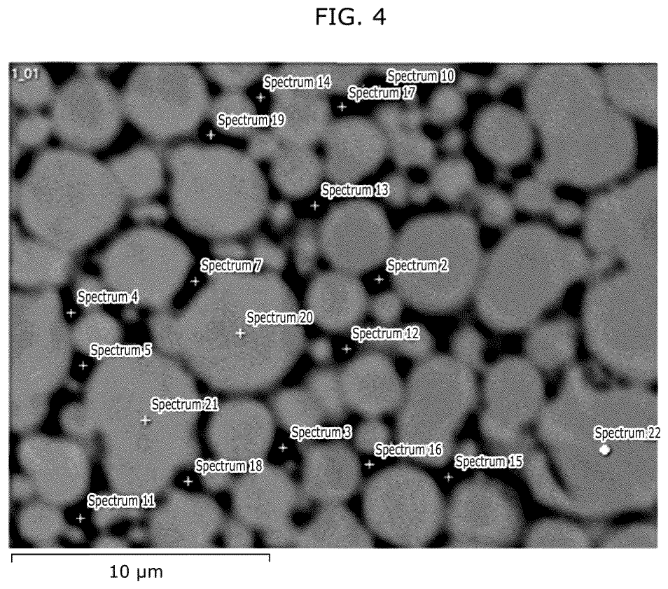

After each of the fabricated plate-shaped dust cores was embedded in resin and cut, the dust core was subjected to ion milling to form a cross section for observation, and elemental analysis of the dust core was performed based on the image of the cross section using SEM-EDX. Specifically, as the measurement points in the image of the cross section, 15 locations between the particles of the metal magnetic powder (i.e., locations where the binding agent is present) were selected in a manner that the locations are distributed in the entire image, and each element was detected on a weight basis from the EDX spectrum obtained at each measurement point. FIG. 4 is a diagram showing an image of a cross section of a dust core according to Evaluation Example 6. FIG. 4 shows a SEM image of a cross section formed using the method described above. The magnification of the SEM image shown in FIG. 4 is 5000 times. In the image in FIG. 4, the black regions represent the binding agent and the white crosses on the black regions represent the measurement points. As shown in FIG. 4, the locations of 15 measurement points were determined to be measurement points between different metal magnetic particles of the metal magnetic powder. The size of the region to be measured at each measurement point was 393.6 nm². Dust cores other than the dust core according to Evaluation Example 6 were also subjected to elemental analysis in the same manner.

Based on the elemental analysis result, the content of the Cr element and the content of the Zn element at each measurement point were calculated. The content of the Cr element at each measurement point was the percentage (wt %) of the Cr element relative to the sum of the Si element, the C element, the O element, the N element, and the Cr element calculated based on the elemental analysis result. The content of the Zn element at each measurement point was the percentage (wt %) of the Zn element relative to the sum of the Si element, the C element, the O element, the N element, and the Zn element calculated based on the elemental analysis result.

Table 1 shows the amount of the Cr element detected at each measurement point in Evaluation Example 6. Note that in the elemental analysis, the Fe element considered as deriving from the metal magnetic powder existing in the depth direction of the cross section was also detected, and table 1 also shows the amount of the Fe element detected. The amount of the Fe element detected at each measurement point shown in Table 1 was the percentage (wt %) of the Fe element relative to the sum of the Si element, the C element, the O element, the N element, the Cr element, and the Fe element calculated based on the elementary analysis result.

TABLE 1

| | Amount of Cr | Amount of Fe |
|---|---|---|
| Measurement | detected | detected |
| point | wt % | wt % |
| 1 | 5.1 | 80.4 |
| 2 | 5.0 | 82.0 |
| 3 | 4.5 | 84.4 |
| 4 | 6.8 | 75.0 |
| 5 | 5.6 | 78.5 |
| 6 | 6.9 | 84.1 |
| 7 | 4.5 | 80.1 |
| 8 | 18.9 | 96.3 |
| 9 | 2.6 | 62.1 |
| 10 | 4.3 | 76.8 |
| 11 | 3.1 | 74.5 |
| 12 | 4.2 | 83.4 |
| 13 | 10.7 | 87.8 |
| 14 | 10.3 | 91.3 |
| 15 | 11.2 | 89.3 |

As shown in Table 1, at measurement points where the amount of the Fe element detected was high, the amount of the Cr element detected was also high. In the EDX spectrum, when the amount of the Fe element detected was high, the detection precision of other elements decreased because of the influence of the Fe element, and in particular, the Si element, the C element, and the O element were more likely to escape detection, so that the amount of the Cr element detected also increased. Therefore, among the 15 measurement points, data for the measurement points where the amount of the Fe element detected was greater than 88.0 wt % (data for measurement points 8, 14, and 15 underlined in Table 1) was omitted, and an average value of the amounts of the Cr element detected at the remaining measurement points was regarded as the amount of the Cr element detected in the binding agent in each evaluation example.

For the amount of the Zn element detected, as with the amount of the Cr element detected, an average value of the amounts of the Zn element detected at the measurement points excluding the measurement points where the amount of the Fe element detected was greater than 88.0 wt % was regarded as the amount of the Zn element detected in the binding agent in each evaluation example.

For the evaluation examples other than Evaluation Example 6, the amount of the Cr element detected in the binding agent and the amount of the Zn element detected in the binding agent were calculated in the same manner as that in Evaluation Example 6.

### [Results of Analysis and Evaluation]

In the manner described above, analysis and evaluation of the dust cores in Evaluation Examples 1 to 10 were performed. The result is shown in Table 2. Table 2 shows results of evaluation of the added amount of the resin mixed, the type and added amount of the metallic soap mixed, the amount of the Cr element detected in the binding agent, the amount of the Zn element detected in the binding agent, the magnetic permeability μᵢ ratio, the magnetic permeability μ_{85Oe} ratio, the breakdown voltage, and the anti-rust effect of the dust cores in Evaluation Examples 1 to 10.

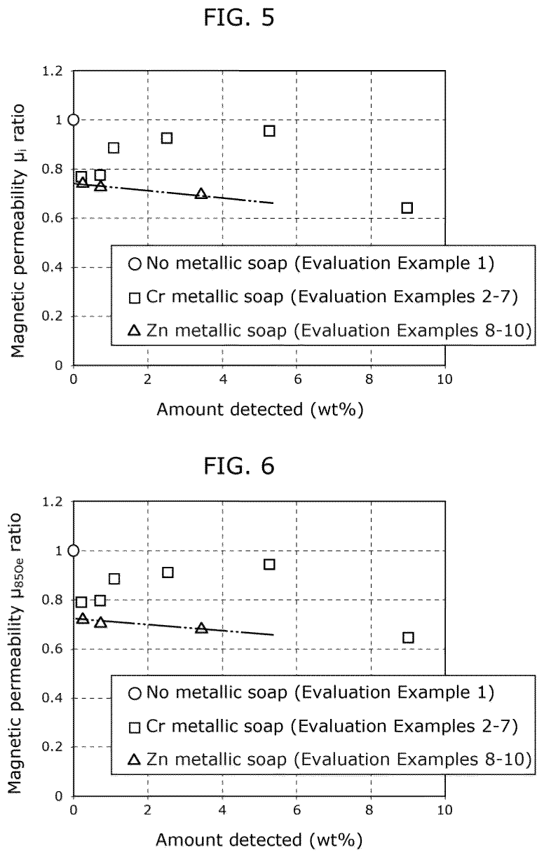

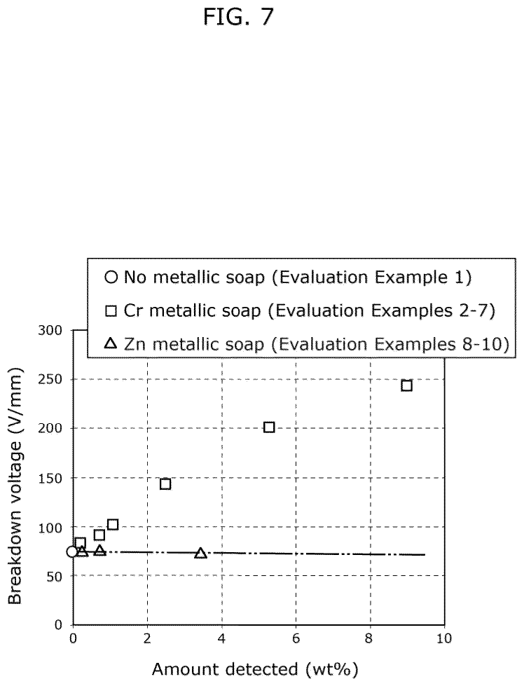

FIG. 5 is a diagram showing a relationship between the amount of the Cr element or Zn element detected and the magnetic permeability μᵢ ratio of the dust cores in the evaluation examples shown in Table 2. FIG. 6 is a diagram showing a relationship between the amount of the Cr element or Zn element detected and the magnetic permeability μ_{85Oe} ratio of the dust cores in the evaluation examples shown in Table 2. FIG. 7 is a diagram showing a relationship between the amount of the Cr element or Zn element detected and the breakdown voltage of the dust cores in the evaluation examples shown in Table 2. In FIGS. 5 to 7, data of Evaluation Example 1 in which no metallic soap was added is indicated by a circle marker, data of Evaluation Examples 2 to 7 in which the Cr metallic soap was added is indicated by a square marker, and data of Evaluation Examples 8 to 10 in which the Zn metallic soap was added is indicated by a triangle marker. In FIGS. 5 to 7, the horizontal axis indicates the amount of the Cr element detected for Evaluation Examples 2 to 7 and indicates the amount of Zn element detected for Evaluation Examples 8 to 10.

TABLE 2

| | Added | | Added | Amount | Amount | | | | |
|---|---|---|---|---|---|---|---|---|---|
| | amount | Type of | amount of | of Cr | of Zn | | | Breakdown | |
| | of resin | metallic | metallic soap | detected | detected | μᵢ | μ_{SSOe} | voltage | Anti-rust |
| | wt % | soap | wt % | wt % | wt % | ratio | ratio | V/mm | effect |
| Evaluation | 3 | — | 0 | 0 | 0 | 1.00 | 1.00 | 75 | x |
| Example 1 | | | | | | | | | |
| Evaluation | 3 | Fatty acid | 0.10 | 0.20 | 0 | 0.77 | 0.79 | 84 | ∘ |
| Example 2 | | chromium | | | | | | | |
| Evaluation | 3 | Fatty acid | 0.25 | 0.71 | 0 | 0.78 | 0.79 | 91 | ∘ |
| Example 3 | | chromium | | | | | | | |
| Evaluation | 3 | Fatty acid | 0.50 | 1.08 | 0 | 0.89 | 0.89 | 103 | ∘ |
| Example 4 | | chromium | | | | | | | |
| Evaluation | 3 | Fatty acid | 1.0 | 2.50 | 0 | 0.93 | 0.92 | 144 | ∘ |
| Example 5 | | chromium | | | | | | | |
| Evaluation | 3 | Fatty acid | 2.0 | 5.28 | 0 | 0.95 | 0.94 | 202 | ∘ |
| Example 6 | | chromium | | | | | | | |
| Evaluation | 3 | Fatty acid | 4.0 | 8.97 | 0 | 0.64 | 0.65 | 244 | ∘ |
| Example 7 | | chromium | | | | | | | |
| Evaluation | 3 | Fatty | 0.10 | 0 | 0.25 | 0.75 | 0.73 | 76 | ∘ |
| Example 8 | | acid zinc | | | | | | | |
| Evaluation | 3 | Fatty | 0.20 | 0 | 0.72 | 0.73 | 0.71 | 77 | ∘ |
| Example 9 | | acid zinc | | | | | | | |
| Evaluation | 3 | Fatty | 0.50 | 0 | 3.43 | 0.70 | 0.69 | 74 | ∘ |
| Example 10 | | acid zinc | | | | | | | |

As shown in Table 2, in Evaluation Example 1 in which no metallic soap was added, in the evaluation of the anti-rust effect, rust was observed, and it was found that rust occurred. On the other hand, with the dust cores in Evaluation Examples 2 to 10 in which the metallic soap was added, no rust was observed, and it was found that the anti-rust effect was improved. In Evaluation Examples 8 to 10, it can be considered that the Zn metallic soap, which is in a solid state at room temperature, formed a solid coating that covers the surface of the metal magnetic particles of the metal magnetic powder to improve the anti-rust effect. in Evaluation Examples 2 to 7, it can be considered that the Cr element having a high corrosion resistance against rust in the Cr metallic soap, which is in a liquid state at room temperature, reacts with the surface of the metal magnetic powder to improve the anti-rust effect of the metal magnetic powder.

As shown in Table 2 and FIGS. 5 and 6, with the dust cores in Evaluation Examples 8 to 10 in which the Zn metallic soap was added, the magnetic permeability μᵢ ratio and the magnetic permeability μ_{85Oe} ratio decreased as the amount of the Zn element detected increased (this is indicated by the alternate long and two short dashes line in FIGS. 5 and 6). To the contrary, with the dust cores in Evaluation Examples 2 to 7 in which the Cr metallic soap was added, the monotonic decrease of the magnetic permeability μᵢ ratio and the magnetic permeability μ_{85Oe} ratio observed in Evaluation Examples 8 to 10 did not occur as the amount of the Cr element detected increased. In particular, the magnetic permeability μᵢ ratio and the magnetic permeability μ_{85Oe} ratio of the dust cores in Evaluation Examples 2 to 6 were higher than those of the dust cores in Evaluation Examples 8 to 10. In the range of the amount of the Cr element detected in the binding agent from 0.20 wt % to 5.28 wt %, the magnetic permeability μᵢ ratio and the magnetic permeability μ_{85Oe} ratio increased as the amount of the Cr element detected increased. It can be considered that this was because the Cr metallic soap dispersed in the resin had a Cr part having high affinity with the metal magnetic powder and a fatty acid part having high affinity with the resin and therefore attracted the resin and the metal magnetic powder to reduce the distances between the metal magnetic particles of the metal magnetic powder. On the other hand, in Evaluation Examples 8 to 10, it can be considered that the Zn metallic soap formed a coating on the surface of the metal magnetic particles of the metal magnetic powder to increase the distances between the metal magnetic particles, so that the magnetic permeability μᵢ ratio and the magnetic permeability μ_{85Oe} ratio decreased as the amount of the Zn element detected increased.

As shown in Table 2 and FIG. 7, with the dust cores in Evaluation Examples 2 to 7 in which the Cr metallic soap was added, the breakdown voltage increased as the amount of the Cr element detected increased. In other words, the breakdown voltage increased as the added amount of the Cr metallic soap increased. It can be considered that this was because the addition of the Cr metallic soap improved the dispersibility of the resin. On the other hand, with the dust cores in Evaluation Examples 8 to 10 in which the Zn metallic soap was added, the breakdown voltage was substantially constant regardless of the amount of the Zn element detected (this is indicated by the alternate long and two short dashes line in FIG. 7).

### CONCLUSION

As can be seen from the results of analysis and evaluation of the dust cores described above, with the dust cores using the binding agent including the Cr element, occurrence of rust was not observed, the decrease of the magnetic permeability was inhibited, the breakdown voltage increased, and both the magnetic characteristics and the anti-rust effect was able to be achieved. For example, when the dust core using the binding agent including the Cr element was used for an inductor, even though the metal magnetic powder having high saturation magnetic flux density the content of the Fe element in which was at least 99.5 wt % was used, occurrence of rust was able to be inhibited, the DC superimposition characteristics reflecting the high saturation magnetic flux density was able to be achieved, and the eddy current loss was able to be reduced. In particular, when the percentage of the metallic soap including the Cr element relative to the metal magnetic powder was at least 0.1 wt % and at most 2.0 wt %, and as a result, the content of the Cr element in the binding agent in the dust core manufactured was at least 0.20 wt % and at most 5.28 wt %, the magnetic permeability increased as the amount of the Cr element detected increased, and the deterioration of the magnetic characteristics was able to be effectively inhibited.

To the contrary, with the dust cores using the binding agent including no metallic soap, rust occurred, and the anti-rust effect was low. With the dust cores using the binding agent including the Zn metallic soap, although occurrence of rust was not observed, the decrease of the magnetic permeability was not able to be inhibited, and the breakdown voltage did not increase (the insulation properties were not improved).

### Other Embodiments Etc.

Although the dust core and so on according to an embodiment of the present disclosure have been described above, the present disclosure is not limited to this embodiment.

For example, electrical components that include the dust core described above are also included in the present disclosure. Examples of the electrical components include inductance components such as high-frequency reactors, inductors, and transformers. Power supply devices that include the electrical components described above are also included in the present disclosure.

The present disclosure is not limited to the above embodiment. Various modifications to the present embodiment that may be conceived by those skilled in the art, as well as forms resulting from combinations of constituent elements from different embodiments may be included within the scope of one or more aspects, so long as such modifications and forms do not depart from the essence of the present disclosure.

### INDUSTRIAL APPLICABILITY

The dust core according to the present disclosure can be used as a material and the like of the magnetic core of a high frequency inductor or a transformer.

### REFERENCE SIGNS LIST

10 dust core
11 metal magnetic powder
12 binding agent
20, 30 lead portion
25 first terminal member
35 second terminal member
40 coil member
100 electrical component

1. A dust core comprising:
a metal magnetic powder including a plurality of metal magnetic particles; and
a binding agent that binds the plurality of metal magnetic particles of the metal magnetic powder,
wherein the binding agent includes a Cr element.

2. The dust core according to claim 1,
wherein a percentage of the Cr element relative to a sum of a Si element, a C element, an O element, a N element, and the Cr element in the binding agent is at least 0.20 wt % and at most 5.28 wt %.

3. The dust core according to claim 1,
wherein a content of an Fe element in the metal magnetic powder is at least 90.0 wt %.

4. The dust core according to claim 3,
wherein the content of the Fe element in the metal magnetic powder is at least 99.5 wt %.

5. A method for manufacturing a dust core, the method comprising:
mixing a metal magnetic powder, a resin, and a metallic soap to obtain a granulated powder in which the metal magnetic powder and a binding agent including the resin and the metallic soap are mixed, the metal magnetic powder including a plurality of metal magnetic particles; and
pressure-molding the granulated powder obtained,
wherein in the mixing, the metallic soap is in liquid form at 25° C. and includes a Cr element.

6. The method according to claim 5,
wherein in the mixing, a percentage of the metallic soap relative to the metal magnetic powder in the granulated powder is at least 0.1 wt % and at most 2.0 wt %.

7. The method according to claim 5,
wherein in the pressure-molding, a percentage of the Cr element relative to a sum of a Si element, a C element, an O element, a N element, and the Cr element in the binding agent included in the granulated powder that is pressure-molded is at least 0.20 wt % and at most 5.28 wt %.

8. The method according to claim 5,
wherein in the mixing, the granulated powder is obtained by obtaining a mixture of the metal magnetic powder and the metallic soap and then mixing the mixture and the resin.
